(19) United States
(12) Patent Application Publication
(10) Pub. No.: US 2026/0124869 A1
(43) Pub. Date: May 7, 2026

(54) TILITING SUSPENSION SYSTEM FOR A VEHICLE AND CONTROL METHOD FOR TILITING A VEHICLE

(71) Applicant: UAB RIMTI RATAI, Rietavas (LT)

(72) Inventors: Arturas Mikalauskas, Vilniaus r. (LT); Jurgis Lecas, Rietavo sav (LT); Lukas Baciauskas, Vilniaus raj. (LT)

(21) Appl. No.: 19/336,670

(22) Filed: Sep. 23, 2025

Related U.S. Application Data
(60) Provisional application No. 63/714,189, filed on Oct. 31, 2024.

(51) Int. Cl. B60G 17/019

(52) U.S. Cl. CPC B60G 17/01933; B60G 2300/12; B60G 2400/204; B60G 2400/41; B60G 2800/012

(57) ABSTRACT

The present disclosure is related to a tilting suspension system comprising a frame, a subframe, a longitudinal axis, an independent symmetrical front suspension, a steering mechanism, and a tilting mechanism, a tilt locking mechanism, a wheel alignment and caster adjustment unit, a controllable anti-roll bar unit, and a power tilting unit. The present disclosure is also related to a control method for tilting such a vehicle comprising selecting a driving mode of the vehicle and activating the driving mode.

### PRIORITY

This application claims priority of the U.S. Provisional Application number 63/714,189 which was filed on Oct. 31, 2024 and the content of which is incorporated herein by reference.

### FIELD OF THE INVENTION

The invention relates to the field of automotive, in particular, the present invention relates to a tilting suspension system and a control method for tilting vehicles.

### BACKGROUND ART

As cities grapple with the challenges of CO2 and noise pollution from combustion engine-driven cars, as well as the scarcity of parking space for conventional automobiles, the need for innovative solutions becomes increasingly evident.

Tilting vehicles offer a promising solution by addressing these pain points. Their narrow, compact size, maneuverability, and potential for electric powertrain propulsion make them an ideal fit for urban environments, efficiently transporting individuals or smaller cargo while minimizing environmental impact.

Given the growing market interest in tilting vehicles, advancements have been made to enhance their safety, ease of operation, compactness, and performance, aligning them more closely with conventional automobiles.

In U.S. Pat. No. 7,850,180 a vehicle is disclosed where steering is achieved by turning a steering wheel, which directs front suspension, and the vehicle's tilting is controlled by driver's legs. This is done by moving upper or lower suspension rods directly or through additional rods. However, in tilting vehicles, drivers typically use their legs to maintain body balance, making it uncomfortable to also control the vehicle's tilt with their legs.

Another known solution is disclosed in US patent application, publication No.: US2014091551.The disclosed technology comprises mounting front suspension and steering wheel on front part of a vehicle frame, which is connected to rear part of the frame by an axle that is slightly bent upwards (see patent no.). When the steering wheel is turned to either side, the vehicle body tilts in the same direction, with the tilt angle determined by the angle of the axle. However, a drawback of this design is that the tilt of the vehicle is structurally linked to the steering, limiting independent control over both the tilt and the steering.

Patent no. EP3428048 describes a three-wheeled vehicle with a steering mechanism that features two distinct units: one for steering and one for tilting. Both the steering and tilting are executed relative to the front frame, where the front suspension and steering mechanisms are mounted.

While the steering and tilting mechanisms are independent of each other, they are both controlled by the steering wheel, which rotates around its axis. Similar to the solutions described above, steering and tilting are linked and can only be performed simultaneously, not independently.

U.S. Pat. No. 10,737,720 discloses a vehicle body tilting system that uses a servo motor in conjunction with a mechanical gear reducer. However, this system lacks a torque sensor and a control channel that would directly manage the body's tilt during turns. The vehicle's tilt is not determined by the driver but is instead controlled by the electro-mechanical tilting system. This limitation restricts the functionality and versatility of the tilting vehicle.

Lithuania patent No.: 6792 discloses a three-wheel drive control devices and method of leaning a three wheeled vehicle. Direction of movement of the vehicle is controlled by rotating the steering wheel about its axis and the leaning of the vehicle is controlled by the steering wheel, when the steering shaft is turned to the right and left from the neutral (central) position.

Lithuania patent No.: 6990 discloses a control mechanisms for tilting three-wheeled vehicles.

The control mechanism of a three-wheeled tilting vehicle consists of the steering and the tilting units, which are interconnected with the steering wheel, the steering column, and the steering wheel bushing.

Patent application No.: PCT/IB2020/054225, publication No.: WO2020225716 discloses a leaning tricycle and its steering and a leaning method. Direction of the vehicle is initiated by the steering wheel and the tilt of the vehicle is controlled by tilting the same steering wheel shaft to the left or the right from neutral (center) position. The tilting three-wheeled vehicle consists of the frame, which has a motor, seats, single drive wheel, and the vehicle body in the back, and the two-wheeled independent symmetric suspension with a control unit in the front part of the frame. The solution is unique for its underframe mounted on the frame axles as well as the control unit which consists of two separate units—the steering unit and the tilting unit, both of which are connected by the steering wheel and the steering shaft which is mounted in the steering shaft longitudinal bushing. The steering unit features mechanical components for vehicle steering which are connected between the steering shaft and the wheel knuckles. The tilting unit features the lever connected to the frame, underframe, and the steering shaft longitudinal bushing. The tilting of this vehicle body, including the frame and the seats, and the steering of the front wheels are two separate actions, both of which are performed by the same steering wheel and the steering shaft. Both of these actions can be performed separately.

The present invention is dedicated to overcoming the above shortcomings and for producing further advantages over prior art.

### BRIEF DESCRIPTION OF THE INVENTION

The present invention discloses a tilting suspension system and control method for safely tilting a vehicle into corners. The mechanical nature of such a system ensures reliability, stability, low manufacturing costs and ease of use.

The tilting suspension system and the control method merge the agility and maneuverability of a motorcycle with the safety and stability of a conventional automobile. Steering is accomplished through steering the front wheels, while stability is achieved by tilting the vehicle body and front wheels left or right. Direction of a vehicle is controlled by rotating the steering wheel around its axis, and the tilt of the vehicle is controlled by employing counter-steering or shifting the steering wheel column along a curved trajectory left or right from its neutral (central) position.

The frame of the vehicle is always tilting in respect to a subframe of the vehicle, where the subframe itself always remains in a vertical position. Additional mechanisms, controlled by a driver's hands, legs, or interactive systems, can also be incorporated.

Separate steering and tilting mechanisms operate through separate channels yet are interconnected via a steering column bushing. These mechanisms influence other vehicle systems, such as the frame, subframe (connected along the longitudinal axis), and independent symmetrical front suspension.

The tilting mechanism comprises a main lever and a gear pair, while the steering mechanism comprises the steering column with the steering wheel and a slip joint. The main lever is positioned along the frame and mounted at its end. One end is connected to the steering column bushing, and the other end is connected to the gear pair. The sole connection point between these two distinct systems is the steering column bushing.

The tilting suspension system further comprises a tilt lock mechanism, mounted between the frame and the subframe. Such a mechanism is controlled by the user or a control mechanism and can be designed in several ways, all of which ensure that the frame gets fixed and locked in respect to the subframe at any desired tilt position, until the tilt-lock is disengaged. The main approach is a friction clutch actuated by hydraulic gear; another approach can be utilized that uses only hydraulics.

The tilting suspension system further comprises a wheel alignment and caster adjustment unit for configuring the independent symmetrical front suspension in several ways, ensuring optimal settings depending on the road and driving conditions. For this solution, a slider is used. The slider is movably connected with the frame through linear bearings and connected to the top control arms of the independent symmetrical front suspension.

The tilting suspension system further comprises a controllable anti-roll bar unit for improving stability of the vehicle.

The tilting suspension system further comprises a power-tilting unit. The power-tilting unit safely assists the mechanical tilting mechanism. The power-tilting unit comprises a torque sensor, a safety coupler, and an electric gear, consisting of an electric motor and a gear reducer. The inputs of the controller are connected to the tilt angle sensor, wheel steering angle sensor, speed sensor, inertial measurement unit, pressure sensor, and drive mode selector. The outputs of the controller are connected to the motor controller and the safety coupler.

### BRIEF DESCRIPTION OF THE DRAWINGS

Features of the invention believed to be novel and inventive are set forth with particularity in the appended claims. The invention itself, however, may be best understood by reference to the following detailed description of the invention, which describes exemplary embodiments, given in non-restrictive examples, of the invention, taken in conjunction with the accompanying drawings, in which:

FIG. 1 shows the main kinematic diagram of embodiment of control mechanism according to the invention. The control mechanism comprises a frame, a subframe, a longitudinal axis, a steering mechanism with a slip joint, and a tilting mechanism with a gear pair. The steering is performed via the steering column and the tilting is performed via the main lever.

FIG. 2 shows the electromechanical-hydraulic diagram of the power tilting unit and the tilt-locking mechanism according to the invention.

FIG. 3 shows a schematic representation of the power tilting unit control mechanism according to the invention.

FIG. 4 shows a kinematic diagram of the control mechanism according to the invention further comprising a wheel alignment and caster adjustment unit.

FIG. 5 shows the kinematic diagram of the control mechanism according to the invention further comprising a controllable anti-roll bar unit.

Preferred embodiments of the invention will be described herein below with reference to the drawings. Each figure contains the same numbering for the same or equivalent element.

### DETAILED DESCRIPTION OF PREFERRED EMBODIMENTS

It should be understood that numerous specific details are presented in order to provide a complete and comprehensible description of the invention embodiment. However, the person skilled in art will understand that the embodiment examples do not limit the application of the invention which can be implemented without these specific instructions. Well-known methods, procedures and components have not been described in detail for the embodiment to avoid misleading. Furthermore, this description should not be considered to be constraining the invention to given embodiment examples but only as one of possible implementations of the invention.

A tilting suspension system according to the invention comprises a frame (1), a subframe (2), a longitudinal axis (3), an independent symmetrical front suspension (4), a steering mechanism (5), and a tilting mechanism (6), a tilt locking mechanism (7), a wheel alignment and caster adjustment unit (8), a controllable anti-roll bar unit (9), and a power tilting unit (10).

The steering mechanism (5) comprises a steering wheel (5.1), a steering column (5.2), a steering column bushing (5.3), a universal joint (5.4), a steering link axle (5.5), a steering link (5.6), a slip joint (5.7), and a tie rods (5.8). The tilting mechanism (6) comprises a main lever (6.1) connected at one end to the steering column bushing (5.3) and at the other end connected to a pinion (6.5). The main lever (6.1) is movably attached to the frame (1) via two bearing-axis joints (6.2,6.3). The pinion (6.5) is mounted on the frame (1) while a gear (6.6) is mounted on the subframe (2), forming a gear pair (6.4). FIG. 1 demonstrates the tilting mechanism, which operates through separate channels for tilting and steering, using the main lever (6.1) and steering column (5.2) respectively.

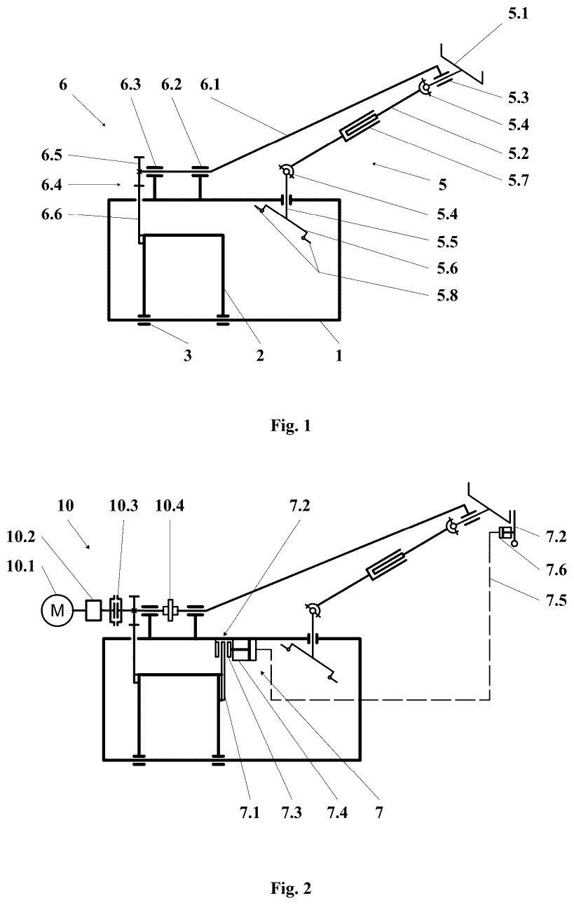

The electromechanical-kinematic diagram in FIG. 2 expands upon that of FIG. 1 by further comprising the tilt locking mechanism (7) and the power tilting unit (10). The tilt locking mechanism (7) comprises a friction segment (7.1), which is connected to the subframe (2), and a friction caliper (7.2) that houses friction pads (7.3) and a hydraulic cylinder (7.4). The hydraulic cylinder (7.4) connects to a hydraulic control cylinder (7.6) through a hydraulic line (7.5). The hydraulic control cylinder (7.6) is operated by a tilt lock handle (7.7). The power tilting unit (10) comprises a motor (10.1), gear reducer (10.2), safety coupler (10.3), and torque sensor (10.4).

The tilt locking mechanism (7) allows the driver to secure the frame (1) and the subframe (2) of the vehicle at any desired tilt angle. The locking force varies based on the pressure applied to the tilt lock handle (7.7), ranging from minimal (when the handle is untouched) to maximum (when fully engaged). Consequently, the friction between the frame (1) and the subframe (2) adjusts accordingly unlocked, partially locked, or fully locked.

The schematic diagram in FIG. 3 shows a representation of the tilting mechanism controller. Electrical connections are shown as straight lines, while mechanical connections are depicted as dashed lines. The tilt controller (10.5) comprises inputs connected to a tilt angle sensor (10.7), a wheel steering angle sensor (10.8), a speed sensor (10.9), a pressure sensor (10.10), an inertial measurement unit (10.11), a drive mode selector (10.12), and a torque sensor (10.4). The outputs of the tilt controller (10.5) are connected to a motor controller (10.6), which directly controls the motor (10.1) and the safety coupler (10.3).

Before operating the vehicle, the drive mode selector (10.12) is used to choose a preferred driving mode, activating the tilt controller (10.5). When the main lever (6.1) is tilted to the left or right from its central (neutral) position, the torque sensor (10.4) sends a signal proportional to the tilt force. This signal is amplified by the tilt controller (10.5), which then activates the motor (10.1) through the motor controller (10.6). The motor (10.1) turns the gear pair (6.4) via the gear reducer (10.2) and the safety coupler (10.3), facilitating easier tilting of the main lever (6.1).

The primary sensor of the tilting suspension system is the torque sensor (10.4), which converts the torque of the main lever (6.1) into an electrical signal. Together with the tilt angle sensor (10.7), the wheel steering angle sensor (10.8), the speed sensor (10.9), the pressure sensor (10.10), and the inertial measurement unit (10.11) enable the tilt controller (10.5) to calculate the assistive tilting force required by the vehicle driver. This force is subsequently applied to the motor (10.1) via the motor controller (10.6).

The safety coupler (10.3) also improves the safety of the vehicle. When the tilt controller (10.5) detects any kind of error in the system (such as a lost connection with a sensor or multiple sensors), it immediately disconnects the safety coupler (10.3) from the motor (10.1) and the gear reducer (10.2), thereby switching the drive mode of the vehicle to fully manual.

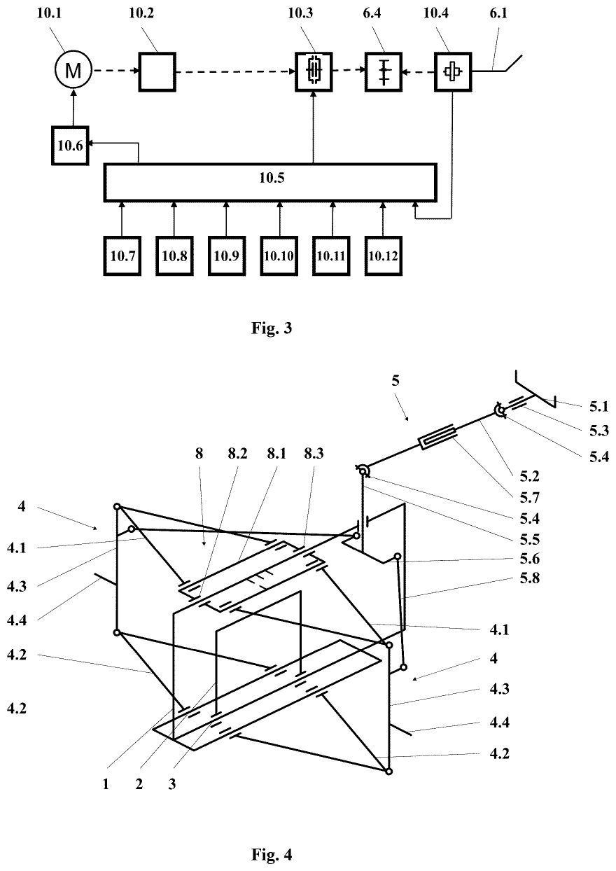

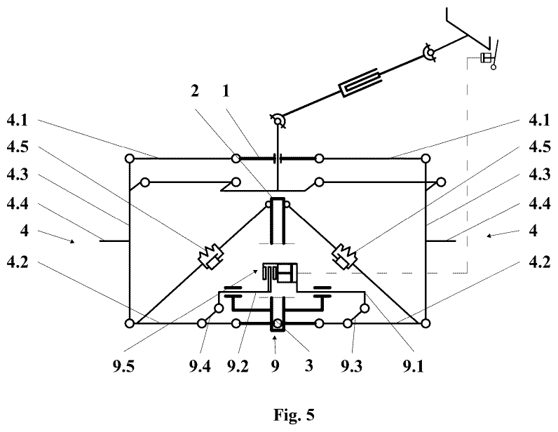

The wheel alignment and caster adjustment unit (8), as shown in FIG. 4, comprises a slider (8.1) connected to the frame (1) via linear bearings (8.2, 8.3). The independent symmetrical front suspension (4) comprises symmetrical left and right sides comprising an upper control arm (4.1) and a lower control arm (4.2), both of which are V-shaped (or triangular), a wheel knuckle (4.3) and a wheel axle (4.4). The upper control arm (4.1) is movably connected to the slider (8.1), while the lower control arm (4.2) connects to the frame (1). The pointed ends of both control arms are movably attached to the wheel knuckle (4.3) and the wheel axle (4.4).

It is important to note that the diagram in FIG. 4 does not depict shock absorbers, but they can be seen in FIG. 5. The shock absorbers (4.5) are movably connected to the pointed end of the lower control arm (4.2) at one end and to the subframe (2) at the other end.

This independent symmetrical front suspension (4) differs from typical independent vehicle suspensions in that the frame (1), where the upper control arms (4.1) are mounted, features a slider (8.1) that is movably mounted and capable of sliding along the frame (1).

The wheel alignment and caster adjustment unit (8) operate by moving the slider (8.1) either forward or backward. This adjustment can be performed manually or via an electric or hydraulic drive. Changing the position of the slider (8.1) not only alters the caster angle but also affects wheel alignment: the wheel knuckles (4.3) and wheels shift slightly inward when the slider moves toward the rear of the vehicle and outward when it moves toward the front, enhancing vehicle stability.

The wheel alignment and caster adjustment unit (8) enable configuring the independent symmetrical front suspension (4) in various ways to achieve optimal settings depending on road and driving conditions. The caster angle, crucial for stability, affects steering effort and straight-line stability. A positive caster angle helps center the steering wheel after a turn, making driving slightly harder but enhancing stability on straight roads. On unstable or slippery roads, a more vertical caster angle is preferred. This system allows dynamic adjustment of the caster angle by moving the slider (8.1), which also adjusts wheel alignment to increase vehicle stability.

The kinematic diagram in FIG. 5 shows the frame (1), subframe (2), longitudinal axis (3), independent symmetrical front suspension (4) and the controllable anti-roll bar unit (9). The independent symmetrical front suspension (4) comprises symmetrical left and right sides comprising an upper control arm (4.1) and a lower control arm (4.2), wheel knuckles (4.3), wheel axles (4.4) and shock absorbers (4.5). The controllable anti-roll bar unit (9) comprises torsion bars (9.1, 9.2) connected to the lower control arms (4.2) via links (9.3, 9.4), and further comprises a hydraulic clutch (9.5).

When the frame (1) is not locked with the subframe (2), and the vehicle works “like a motorcycle”, the torsion bars (9.1, 9.2) are not connected and do not affect the operation of the independent symmetrical front suspension (4). The controllable anti-roll bar unit (9) is enabled only when the hydraulic clutch (9.5) connects the torsion bars (9.1, 9.2). The anti-roll bar unit (9) can be controlled by the tilt locking mechanism (7) and by the power tilting unit (10).

The controllable anti-roll bar unit (9) balances the load between both sides of the independent symmetrical front suspension (4). During turns, the wheel knuckles (4.3) move differently: one side rises while the other side lowers. The anti-roll bar unit (9) counteracts this tilt (when the tilt locking mechanism (7) is engaged) to improve tire grip. The hydraulic clutch (9.5) can either connect or disconnect the torsion bars (9.1, 9.2). Preferably the control of the clutch (9.5) is engaged together with the tilt locking mechanism (7). When the tilt locking (7) mechanism engages, the vehicle behaves like an asymmetrical regular car, necessitating the anti-roll bar (9) for enhanced stability during turns.

The drive mode selector (10.12) comprises three main modes:
Mode 1—the tilt controller (10.5) is disabled and the safety coupler (10.3) is disconnected (the tilting is fully manual).
Mode 2—the tilt controller (10.5) is enabled and the safety coupler (10.3) is connected, the torque of the main lever (6.1) is assisted by the power tilting unit (10).
Mode 3—the tilt controller (10.5) is enabled and the safety coupler (10.3) is connected, the torque of the main lever (6.1) is autonomously controlled by the power tilting unit (10).

In the described technical solutions, the tilting of the vehicle frame (1) (along with the seats and the vehicle body) and the steering of the front wheels are two separate actions. Both actions can be performed independently. When the vehicle is stationary, the frame (1) and the entire vehicle body can be tilted without affecting the front wheels, and vice versa—the front wheels can be steered without tilting the frame (1) and the entire vehicle body.

In the driving modes 1 and 2, the final decision on how much the vehicle should be tilted, depending on speed, turn radius, and road conditions, is made by the driver, thereby enhancing the natural driving experience. Depending on the vehicle's purpose, the maximum tilt angle can be limited accordingly.

In the driving mode 3, the power tilting unit (10) autonomously decides and tilts the body depending on the speed of the vehicle, turn radius of the front wheels, and inertial measurement unit (10.11). In particular, in the driving mode 3, the power tilting unit (10) autonomously decides and tilts the body depending on reading from a tilt angle sensor (10.7), a wheel steering angle sensor (10.8), a speed sensor (10.9), a pressure sensor (10.10), and inertial measurement unit (10.11).

The main purpose of the tilt locking mechanism (7) is to expand the driving capabilities and functionality of a tilting vehicle.

When the vehicle is tilted during a turn, the steering wheel (5.1) and the steering column (5.2) experience external forces depending on the vehicle's speed. The tilt locking mechanism (7) helps to reduce and minimize these additional external forces. Locking the frame (1) and the subframe (2) during turns decreases the external forces felt by the driver's hands, making it easier to control the vehicle and allowing it to maintain the chosen trajectory at higher speeds.

The present disclosure also relates to:

1. A tilting suspension system comprising a frame (1), a subframe (2), a longitudinal axis (3), an independent symmetrical front suspension (4), a steering mechanism (5), and a tilting mechanism (6), wherein the tilting suspension system further comprises a tilt locking mechanism (7).

2. A tilting suspension system according to clause 1, further comprising a wheel alignment and caster adjustment unit (8).

3. A tilting suspension system according to clause 1 or 2, further comprising a controllable anti-roll bar unit (9).

4. A tilting suspension system according to any previous clauses 1-3, further comprising a power tilting unit (10), a tilt controller (10.5), a motor controller (10.6), where the power tilting unit (10) comprises a motor (10.1), gear reducer (10.2), safety coupler (10.3), and torque sensor (10.4).

5. The tilting suspension system according to clause 1, wherein the tilt locking mechanism (7) comprises a friction segment (7.1), which is connected to the subframe (2), and a friction caliper (7.2) that houses friction pads (7.3) and a hydraulic cylinder (7.4), where the hydraulic cylinder (7.4) connects to a hydraulic control cylinder (7.6) through a hydraulic line (7.5), where the hydraulic control cylinder (7.6) is operated by a tilt lock handle (7.7),

6. The tilting suspension system according to any previous clauses, wherein
the independent symmetrical front suspension (4) comprises symmetrical left and right sides comprising an upper control arm (4.1) and a lower control arm (4.2), both of which are V-shaped, a wheel knuckle (4.3) and a wheel axle (4.4), where the upper control arm (4.1) is movably connected to the slider (8.1), while the lower control arm (4.2) connects to the frame (1), and the pointed ends of both control arms are movably attached to the wheel knuckle (4.3) and the wheel axle (4.4).
the steering mechanism (5) comprises a steering wheel (5.1), a steering column (5.2), a steering column bushing (5.3), a universal joint (5.4), a steering link axle (5.5), a steering link (5.6), a slip joint (5.7), and a tie rods (5.8). the tilting mechanism (6) comprises a main lever (6.1) connected at one end to the steering column bushing (5.3) and at the other end connected to a pinion (6.5), where the main lever (6.1) is movably attached to the frame (1) via two bearing-axis joints (6.2, 6.3) and the pinion (6.5) is mounted on the frame (1) while a gear (6.6) is mounted on the subframe (2), forming a gear pair (6.4).

7. The tilting suspension system according to clause 4 or 6, where the tilt controller (10.5) further comprises inputs connected to a tilt angle sensor (10.7), a wheel steering angle sensor (10.8), a speed sensor (10.9), a pressure sensor (10.10), an inertial measurement unit (10.11), a drive mode selector (10.12), and a torque sensor (10.4), and the outputs of the tilt controller (10.5) are connected to a motor controller (10.6).

8. The tilting suspension system according to any one of clauses 2 or 6, where the wheel alignment and caster adjustment unit (8) comprises a slider (8.1) connected to the frame (1) via linear bearings (8.2, 8.3).

9. The tilting suspension system according to clause 3 or 6, where the controllable anti-roll bar unit (9) comprises torsion bars (9.1, 9.2) connected to the lower control arms (4.2) via links (9.3, 9.4), and further comprises a hydraulic clutch (9.5).

10. A control method for tilting a vehicle comprising a tilting suspension system comprising a frame (1), a subframe (2), a longitudinal axis (3), an independent symmetrical front suspension (4), a steering mechanism (5), and a tilting mechanism (6) and a tilt locking mechanism (7), a wheel alignment and caster adjustment unit (8), a controllable anti-roll bar unit (9), and a power tilting unit (10), a tilt controller (10.5), a motor controller (10.6), wherein the method comprises selecting a driving mode of the vehicle and activating the tilt controller (10.5), where
the tilt controller (10.5) is disabled and the safety coupler (10.3) is disconnected, or
the tilt controller (10.5) is enabled and the safety coupler (10.3) is connected, the torque of the main lever (6.1) is assisted by the power tilting unit (10), or
the tilt controller (10.5) is enabled and the safety coupler (10.3) is connected, the torque of the main lever (6.1) is autonomously controlled by the power tilting unit (10) and the power tilting unit (10) autonomously decides and tilts the body depending on reading from a tilt angle sensor (10.7), a wheel steering angle sensor (10.8), a speed sensor (10.9), a pressure sensor (10.10), and inertial measurement unit (10.11),
a torque sensor (10.4) sends a signal proportional to the tilt force when the main lever (6.1) is tilted to the left or right from its central position, where the signal is amplified by the tilt controller (10.5), which then activates the motor (10.1) through the motor controller (10.6), where the motor (10.1) turns the gear pair (6.4) via the gear reducer (10.2) and the safety coupler (10.3), facilitating easier tilting of the main lever (6.1),
calculating the assistive tilting force required by the vehicle driver using the tilt controller (10.5) from signals of a tilt angle sensor (10.7), a wheel steering angle sensor (10.8), a speed sensor (10.9), a pressure sensor (10.10), and inertial measurement unit (10.11), which force is subsequently applied to the motor (10.1) via the motor controller (10.6),
securing the frame (1) and the subframe (2) of the vehicle at any tilt angle using the tilt locking mechanism (7), where the tilt angle is chosen by the driver of the vehicle, where locking force is varied based on pressure applied to a tilt lock handle (7.7), adjusting friction between the frame (1) and the subframe (2) to unlocked, partially locked, or fully locked,
switching the drive mode of the vehicle to fully manual by disconnecting the safety coupler (10.3) from the motor (10.1) and the gear reducer (10.2), if an error in the tilting suspension system is detected by the tilt controller (10.5)

11. A control method for tilting a vehicle according to clause 10, where the wheel alignment and caster adjustment unit (8) operate by moving the slider (8.1) either forward or backward, where changing the position of the slider (8.1) alters the caster angle and wheel alignment, where wheel knuckles (4.3) and wheels shift slightly inward when the slider moves toward the rear of the vehicle and outward when it moves toward the front, configuring independent symmetrical front suspension (4) to increase vehicle stability.

12. A control method for tilting a vehicle according to clause 10 or 11, the controllable anti-roll bar unit (9) is enabled when the hydraulic clutch (9.5) connects the torsion bars (9.1, 9.2), the anti-roll bar unit (9) is controlled by the tilt locking mechanism (7) and by the power tilting unit (10), and when the frame (1) is not locked with the subframe (2) the torsion bars (9.1, 9.2) are not connected and do not affect the operation of the independent symmetrical front suspension (4),
where the controllable anti-roll bar unit (9) balances the load between both sides of the independent symmetrical front suspension (4), where during turns, the wheel knuckles (4.3) move so that one side rises while the other side lowers, where the anti-roll bar unit (9) counteracts this tilt when the tilt locking mechanism (7) is engaged to improve tire grip,
where the hydraulic clutch (9.5) either connect or disconnect the torsion bars (9.1, 9.2),
the control of the clutch (9.5) is engaged together with the tilt locking mechanism (7).

13. A control method for tilting a vehicle according to any one clauses 10-12, wherein the tilting of the vehicle frame (1) along with the seats and the vehicle body and the steering of the front wheels are performed as separate independent actions, and
where when the vehicle is stationary, the frame (1) and the entire vehicle body is tilted without affecting the front wheels, and the front wheels are steered without tilting the frame (1) and the entire vehicle body.

The suggested technical solution is suitable for use in a variety of vehicles, regardless of their size or weight. It is not limited by the number of wheels, but for vehicles with four wheels, the rear suspension must be independent for the solution to function properly.

1. A tilting suspension system comprising a frame (1), a subframe (2), a longitudinal axis (3), an independent symmetrical front suspension (4), a steering mechanism (5), and a tilting mechanism (6), wherein the tilting suspension system further comprises a tilt locking mechanism (7).

2. A tilting suspension system according to claim 1, further comprising a wheel alignment and caster adjustment unit (8).

3. A tilting suspension system according to claim 1, further comprising a controllable anti-roll bar unit (9).

4. A tilting suspension system according to claim 1, further comprising a power tilting unit (10), a tilt controller (10.5), a motor controller (10.6), wherein the power tilting unit (10) comprises a motor (10.1), gear reducer (10.2), safety coupler (10.3), and torque sensor (10.4).

5. The tilting suspension system according to claim 1, wherein the tilt locking mechanism (7) comprises a friction segment (7.1), which is connected to the subframe (2), and a friction caliper (7.2) that houses friction pads (7.3) and a hydraulic cylinder (7.4), wherein the hydraulic cylinder (7.4) connects to a hydraulic control cylinder (7.6) through a hydraulic line (7.5), wherein the hydraulic control cylinder (7.6) is operated by a tilt lock handle (7.7).

6. The tilting suspension system according to claim 1, wherein
the independent symmetrical front suspension (4) comprises symmetrical left and right sides comprising an upper control arm (4.1) and a lower control arm (4.2), both of which are V-shaped, a wheel knuckle (4.3) and a wheel axle (4.4), wherein the upper control arm (4.1) is movably connected to the slider (8.1), while the lower control arm (4.2) connects to the frame (1) and the pointed ends of both control arms are movably attached to the wheel knuckle (4.3) and the wheel axle (4.4),
the steering mechanism (5) comprises a steering wheel (5.1), a steering column (5.2), a steering column bushing (5.3), a universal joint (5.4), a steering link axle (5.5), a steering link (5.6), a slip joint (5.7), and a tie rods (5.8),
the tilting mechanism (6) comprises a main lever (6.1) connected at one end to the steering column bushing (5.3) and at the other end connected to a pinion (6.5), wherein the main lever (6.1) is movably attached to the frame (1) via two bearing-axis joints (6.2, 6.3) and the pinion (6.5) is mounted on the frame (1) while a gear (6.6) is mounted on the subframe (2), forming a gear pair (6.4).

7. The tilting suspension system according to claim 4, wherein the tilt controller (10.5) further comprises inputs connected to a tilt angle sensor (10.7), a wheel steering angle sensor (10.8), a speed sensor (10.9), a pressure sensor (10.10), an inertial measurement unit (10.11), a drive mode selector (10.12), and a torque sensor (10.4), and the outputs of the tilt controller (10.5) are connected to a motor controller (10.6).

8. The tilting suspension system according to claim 2, wherein the wheel alignment and caster adjustment unit (8) comprises a slider (8.1) connected to the frame (1) via linear bearings (8.2, 8.3).

9. The tilting suspension system according to claim 3, wherein the controllable anti-roll bar unit (9) comprises torsion bars (9.1, 9.2) connected to the lower control arms (4.2) via links (9.3, 9.4), and further comprises a hydraulic clutch (9.5).

10. A tilting suspension system according to claim 2, further comprising a controllable anti-roll bar unit (9).

11. A tilting suspension system according to claim 2, further comprising a power tilting unit (10), a tilt controller (10.5), a motor controller (10.6), wherein the power tilting unit (10) comprises a motor (10.1), gear reducer (10.2), safety coupler (10.3), and torque sensor (10.4).

12. The tilting suspension system according to claim 2, wherein
the independent symmetrical front suspension (4) comprises symmetrical left and right sides comprising an upper control arm (4.1) and a lower control arm (4.2), both of which are V-shaped, a wheel knuckle (4.3) and a wheel axle (4.4), wherein the upper control arm (4.1) is movably connected to the slider (8.1), while the lower control arm (4.2) connects to the frame (1), and the pointed ends of both control arms are movably attached to the wheel knuckle (4.3) and the wheel axle
the steering mechanism (5) comprises a steering wheel (5.1), a steering column (5.2), a steering column bushing (5.3), a universal joint (5.4), a steering link axle (5.5), a steering link (5.6), a slip joint (5.7), and a tie rods (5.8),
the tilting mechanism (6) comprises a main lever (6.1) connected at one end to the steering column bushing (5.3) and at the other end connected to a pinion (6.5), wherein the main lever (6.1) is movably attached to the frame (1) via two bearing-axis joints (6.2, 6.3) and the pinion (6.5) is mounted on the frame (1) while a gear (6.6) is mounted on the subframe (2), forming a gear pair (6.4).

13. The tilting suspension system according to claim 6, wherein the tilt controller (10.5) further comprises inputs connected to a tilt angle sensor (10.7), a wheel steering angle sensor (10.8), a speed sensor (10.9), a pressure sensor (10.10), an inertial measurement unit (10.11), a drive mode selector (10.12), and a torque sensor (10.4), and the outputs of the tilt controller (10.5) are connected to a motor controller (10.6).

14. The tilting suspension system according to claim 6, wherein the wheel alignment and caster adjustment unit (8) comprises a slider (8.1) connected to the frame (1) via linear bearings (8.2, 8.3).

15. The tilting suspension system according to claim 6, wherein the controllable anti-roll bar unit (9) comprises torsion bars (9.1, 9.2) connected to the lower control arms (4.2) via links (9.3, 9.4), and further comprises a hydraulic clutch (9.5).

16. A control method for tilting a vehicle comprising a tilting suspension system comprising a frame (1), a subframe (2), a longitudinal axis (3), an independent symmetrical front suspension (4), a steering mechanism (5), and a tilting mechanism (6) and a tilt locking mechanism (7), a wheel alignment and caster adjustment unit (8), a controllable anti-roll bar unit (9), and a power tilting unit (10), a tilt controller (10.5), a motor controller (10.6), wherein the method comprises
selecting a driving mode of the vehicle and activating the tilt controller (10.5), wherein
the tilt controller (10.5) is disabled and the safety coupler (10.3) is disconnected, or
the tilt controller (10.5) is enabled and the safety coupler (10.3) is connected, the torque of the main lever (6.1) is assisted by the power tilting unit (10), or
the tilt controller (10.5) is enabled and the safety coupler (10.3) is connected, the torque of the main lever (6.1) is autonomously controlled by the power tilting unit (10) and the power tilting unit (10) autonomously decides and tilts the body depending on reading from a tilt angle sensor (10.7), a wheel steering angle sensor (10.8), a speed sensor (10.9), a pressure sensor (10.10), and inertial measurement unit (10.11),
a torque sensor (10.4) sends a signal proportional to the tilt force when the main lever (6.1) is tilted to the left or right from its central position, wherein the signal is amplified by the tilt controller (10.5), which then activates the motor (10.1) through the motor controller (10.6), wherein the motor (10.1) turns the gear pair (6.4) via the gear reducer (10.2) and the safety coupler (10.3), facilitating easier tilting of the main lever (6.1),
calculating the assistive tilting force required by the vehicle driver using the tilt controller (10.5) from signals of a tilt angle sensor (10.7), a wheel steering angle sensor (10.8), a speed sensor (10.9), a pressure sensor (10.10), and inertial measurement unit (10.11), which force is subsequently applied to the motor (10.1) via the motor controller (10.6),
securing the frame (1) and the subframe (2) of the vehicle at any tilt angle using the tilt locking mechanism (7), wherein the tilt angle is chosen by the driver of the vehicle, wherein locking force is varied based on pressure applied to a tilt lock handle (7.7), adjusting friction between the frame (1) and the subframe (2) to unlocked, partially locked, or fully locked,
switching the drive mode of the vehicle to fully manual by disconnecting the safety coupler (10.3) from the motor (10.1) and the gear reducer (10.2), if an error in the tilting suspension system is detected by the tilt controller (10.5).

17. A control method for tilting a vehicle according to claim 16, wherein the wheel alignment and caster adjustment unit (8) operate by moving the slider (8.1) either forward or backward, wherein changing the position of the slider (8.1) alters the caster angle and wheel alignment, wherein wheel knuckles (4.3) and wheels shift slightly inward when the slider moves toward the rear of the vehicle and outward when it moves toward the front, configuring independent symmetrical front suspension (4) to increase vehicle stability.

18. A control method for tilting a vehicle according to claim 17,
the controllable anti-roll bar unit (9) is enabled when the hydraulic clutch (9.5) connects the torsion bars (9.1, 9.2), the anti-roll bar unit (9) is controlled by the tilt locking mechanism (7) and by the power tilting unit (10), and when the frame (1) is not locked with the subframe (2) the torsion bars (9.1, 9.2) are not connected and do not affect the operation of the independent symmetrical front suspension (4),
wherein the controllable anti-roll bar unit (9) balances the load between both sides of the independent symmetrical front suspension (4), wherein during turns, the wheel knuckles (4.3) move so that one side rises while the other side lowers, wherein the anti-roll bar unit (9) counteracts this tilt when the tilt locking mechanism (7) is engaged to improve tire grip,
wherein the hydraulic clutch (9.5) either connect or disconnect the torsion bars (9.1, 9.2), the control of the clutch (9.5) is engaged together with the tilt locking mechanism (7).

19. A control method for tilting a vehicle according to claim 16,
the controllable anti-roll bar unit (9) is enabled when the hydraulic clutch (9.5) connects the torsion bars (9.1, 9.2), the anti-roll bar unit (9) is controlled by the tilt locking mechanism (7) and by the power tilting unit (10), and when the frame (1) is not locked with the subframe (2) the torsion bars (9.1, 9.2) are not connected and do not affect the operation of the independent symmetrical front suspension (4),
wherein the controllable anti-roll bar unit (9) balances the load between both sides of the independent symmetrical front suspension (4), wherein during turns, the wheel knuckles (4.3) move so that one side rises while the other side lowers, wherein the anti-roll bar unit (9) counteracts this tilt when the tilt locking mechanism (7) is engaged to improve tire grip,
wherein the hydraulic clutch (9.5) either connect or disconnect the torsion bars (9.1, 9.2),
the control of the clutch (9.5) is engaged together with the tilt locking mechanism (7).

20. A control method for tilting a vehicle according to claim 16, wherein
the tilting of the vehicle frame (1) along with the seats and the vehicle body and the steering of the front wheels are performed as separate independent actions, and
wherein when the vehicle is stationary, the frame (1) and the entire vehicle body is tilted without affecting the front wheels, and the front wheels are steered without tilting the frame (1) and the entire vehicle body.
